(19) United States
(12) Patent Application Publication
(10) Pub. No.: US 2023/0036700 A1
(43) Pub. Date: Feb. 2, 2023

(54) Systems and Methods to Determine a Safe Time to Fire in a Vehicle Inspection Portal

(71) Applicant: Rapiscan Holdings, Inc., Hawthorne, CA (US)

(72) Inventors: Steven Thompson, Coventry (GB); Oliver Dembski, Newcastle-under-Lyme (GB)

(21) Appl. No.: 17/816,987

(22) Filed: Aug. 2, 2022

Related U.S. Application Data
(60) Provisional application No. 63/265,898, filed on Dec. 22, 2021.
(60) Provisional application No. 63/203,837, filed on Aug. 2, 2021.

(51) Int. Cl. G01V 5/00; G01N 23/083; G01N 23/04

(52) U.S. Cl. CPC G01V 5/0066; G01N 23/083; G01N 23/04; G01N 2223/04; G01N 2223/40; G01N 2223/3307

(57) ABSTRACT

A system and method for the accurate determination of a time to fire high energy radiation for security inspection of a cargo vehicle in a drive-through inspection portal. The system includes at least two sensors, one of which is positioned at an entry to the portal, and the other is positioned just after beamline center (BCL). As a driver of the vehicle activates a button at the entry to the portal, the system takes a measurement using one sensor to determine a distance from the driver to a front of the vehicle. As the vehicle reaches the BCL, a measurement is taken by the other sensor in real time and compared with the measurement taken at the entry. A user defined offset is then applied to determine how far behind the driver should the high energy radiation be fired.

### CROSS-REFERENCE

The present application relies on U.S. Patent Provisional Application No. 63/265,898, titled “Systems and Methods to Determine a Safe Time to Fire in a Vehicle Inspection Portal” and filed on Dec. 22, 2021, and U.S. Patent Provisional Application No. 63/203,837, of the same title and filed on Aug. 2, 2021, for priority. Both of the above mentioned applications are incorporated herein in their entirety.

### FIELD

The present specification relates to methods and systems for X-ray inspection. Specifically, embodiments of the present specification relates to the accurate determination of a safe firing time in a vehicle inspection portal.

### BACKGROUND

Linear Accelerators (LINAC) are used at security check points and are incorporated into drive-through portals configured to scan various vehicles including cars and trucks. LINAC systems accelerate charged subatomic particles to a series of oscillating electric potentials as they pass through a sequence of alternating electric fields to generate radiation directed to scanning vehicles along a linear beam line. The LINAC systems accelerate electrons to energies of 3-9 MeV to produce high-energy X-rays for deep penetration. The inspection systems are integrated with computing and imaging components to provide information about the nature of the cargo within the vehicles.

Drive-through portals for vehicle cargo inspection typically include an X-ray radiation transmission unit, such as a LINAC, on one side and a detector on the other side of the portal. Vehicles move slowly through the portal as X-ray fan beams generated by LINAC are detected by a linear array(s) of detectors. While doing so, however, it is essential that the drivers of the vehicles are not exposed to excessively high X-ray radiation. As such, various safety measures have historically been implemented to deliver required radiation doses for scanning the cargo portions of the vehicles, while avoiding exposing drivers to high energy radiation. Conventional approaches include a) having drivers exit the vehicle prior to conducting a scan or b) sensing or controlling the speed of a vehicle, monitoring the profile of the vehicle and, based on the speed and profile, timing the generation of a high radiation dose to only initiate when the cargo portion of the vehicle is in the right location. Both approaches have substantial disadvantages.

First, an approach that requires drivers to exit the vehicle substantially slows down the inspection process and is highly inefficient. Second, a generic approach to initiating cargo scanning by detecting the end of a driver's cab and beginning of the vehicle cargo portion using the vehicle speed and profile is difficult to implement in practice. Driver cabs are situated at different lengths from front of vehicles of different types. Attempts to identify gaps between the driver's cab and cargo often fail because a gap may not exist or may not be detected. Further, speed sensing and/or control mechanisms are often imprecise or difficult to implement at high volumes.

Some of the current laser-based detection systems rely on detection of the gap between a vehicle cab and cargo portions. However, to work, a clear gap of at least 300 millimeters (mm) is needed between the driver cab and the cargo and/or a height profile of the cargo portion needs to meet a predefined threshold value. These methods may run into problems with low loads of machinery and logs which does not meet the height requirement. These limitations may be compounded by vehicles with little or no gap and/or the use of certain types of vehicles which obscure the gap.

Lidar (Light Detection and Ranging) is a remote sensing method that uses pulsed laser to measure reflected light energy that is returned to a Lidar sensor to generate three-dimensional (3D) information of a target object (vehicle). In implementations, a Lidar sensor may be mounted on a horizontal boom, mounted parallel with the side of the boom structure and perpendicular to the road below. Such a structure uses algorithms to sense gap between a cab and cargo portions of a vehicle, as well as the end of scan. The original application of this method and structure was for port tugs, where the size, shape, object types and most variables are consistent, and a huge gap is present. However, when applied to vehicle cargo scanning systems, this method becomes unreliable due to variations in vehicle types and other environmental variables. Lidar is typically used to measure the size and/or height of the target object with pre-determined parameters to ascertain whether the object is a cab, gap, and/or cargo and relies on accurate speed measurement of the vehicle to profile a 3D representation of the vehicle. Measurement systems and methods such as those using Lidar rely on the target object's ability to reflect. However, the reflection is affected by parameters such as color, unusual vehicle shape edges, and weather, because fog, rain, sand, snow and other environmental factors affect performance of these measuring systems.

In some embodiments, Lidar sensors are additionally used to monitor position of cargo throughout an inspection lane. The system and method, also known as approach laser, is mounted on a diagonal plane 140, bisecting the cargo in the inspection lane. FIG. 1A illustrates an image of a laser 141 mounted to detect end of cab of a vehicle and its approach. The laser 141 can measure speed back from the object where the speed radar is not available. An alternative method used for speed monitoring is the use of a doppler radar that is directed down the length of an inspection tunnel. The method provides speed feedback to an algorithm for at least two purposes. First, for slow speed indication, where if a vehicle is travelling at a speed less than 1 kmph, X-ray emissions are stopped and second, for speed feedback where the speed of the vehicle is used to vary the pulse output from the LINAC to correct image aspect ratios.

Unfortunately, the variance between vehicle types, in particular the typical gaps seen, are becoming too difficult for the one Lidar scanner from plan view to detect. Some of the variances include: a) a gap distance that is highly variable from 0 to more than 20 meters, b) gap objects that may include air conditioning, exhausts, among other objects, c) cab types that vary in heights, lengths, and/or axle location, d) items on cab roof that may include a sun roof or air conditioning, and d) cargo variances which may have 40 ft container, 20 ft container on 40 ft trailer, and/or cars among other types. With the prescribed issues, coupled with the ever-increasing variability in vehicles, it is apparent that further solutions are required.

Several alternatives are provided to counter some of the limitations described above. The alternatives include use of barcodes that are manually attached at the end of the cab or start of the cargo. However, manual placement and recycling of the barcodes slows operations at the port/border. Another option is use of radio frequency identification (RFID), which is identical in implementation and limitation to those using barcodes. These methods are slow, logistically challenging to implement, and affect throughput at border security inspection stations.

Therefore, there is a need for reliable measurement method and system that can ensure presence of a vehicle, increase the range of vehicles that can be scanned, decrease the probability of an unintended scan of the driver's cab, maintain as far as possible a free-flowing process and maximize throughput. There is also a need for a solution that works in all appropriate climatic conditions and temperatures. Therefore, there is a need for safety methods and systems that can be integrated into drive-through portals so that high energy radiation exposure is only triggered once a driver has safely passed a LINAC beam center line.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a system for cargo inspection of a vehicle using high energy radiations, the system integrated with a drive-through inspection portal comprising a point of entry followed by a point of radiation, the system comprising: a first sensor located after the point of entry, to detect a first distance blocked by the vehicle at the point of entry; a second sensor to detect a second distance blocked by the vehicle in real time as the vehicle drives through the portal from the point of entry towards the point of radiation, wherein the second sensor is located after the point of radiation; and a controller to compare the second distance and the first distance, and apply an offset once the second distance equals the first distance, wherein the controller triggers the high energy radiations at the vehicle after the offset.

Optionally, the first and the second sensors each comprise at least one of a light array, an ultrasonic beam, microwave emitters and receivers, laser emitters and receivers, and radio frequency (RF) emitters and receivers.

Optionally, the point of entry comprises a button, wherein the first sensor performs the detection when the button is activated by a driver of the vehicle. The button may be a push button. The button may be at least 750 mm before the first sensor.

Optionally, the first distance represents a distance from a front of the vehicle to a driver of the vehicle.

Optionally, the point of radiation comprises a beamline center of a linear accelerator.

Optionally, the second sensor is at least 1750 mm after the point of radiation.

Optionally, the offset is defined by a user operating the controller.

Optionally, the offset is a distance if at least 1000 mm.

Optionally, the system further comprises at least one optical camera to capture the vehicle's profile and identifying markers to create a vehicle profile.

The present specification also discloses a method for cargo inspection of a vehicle using high energy radiations within a drive-through inspection portal comprising a point of entry followed by a point of radiation, the method comprising: detecting activation of a button by a driver of the vehicle at the point of entry; measuring a first distance by a first sensor positioned after the button, wherein the first distance is indicative of a distance from a front of the vehicle to the driver; measuring a second distance by a second sensor positioned after the point of radiation, wherein the second distance is measured in real time as the vehicle moves through the portal from the point of entry towards the point of radiation; comparing the first distance and the second distance; and activating the high energy radiations after the vehicle has crossed an offset when the second distance equals the first distance.

Optionally, the point of radiation comprises a beamline center of a linear accelerator.

Optionally, the method comprises defining the offset by a user.

Optionally, the method further comprises using at least one optical camera to capture the vehicle's profile and identifying markers to create a vehicle profile.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A illustrates a prior art image of a laser mounted to detect an end of cab portion of a vehicle and its approach;

FIG. 1B illustrates three modes of security inspection utilizing scan tunnels at drive-through portals;

FIG. 2A illustrates two fields used by approach laser in a first mode implementation;

FIG. 2B is a flow chart illustrating a process of generating a scan in the first mode;

FIG. 3 is a flow chart that illustrates an exemplary method of generating scan in a third mode;

FIG. 4A illustrates an exemplary setup for inspection of a vehicle in accordance with some embodiments of the present specification;

FIG. 4B is a flow chart that illustrates an exemplary method of inspection using the setup of FIG. 4A, in accordance with some embodiments of the present specification;

FIG. 5A illustrates an exemplary setup for inspection of a vehicle in accordance with some embodiments of the present specification;

FIG. 5B is a flow chart illustrating an exemplary process of inspection using the setup of FIG. 5A, in accordance with some embodiments of the present specification;

FIG. 6 is a flow chart illustrating an exemplary method of detecting a vehicle driving through a security inspection portal so that inspection radiations are activated safely after a driver of the vehicle has crossed the beam center line (BCL) of a linear accelerator (LINAC);

FIG. 7A illustrates a plan view of a first sensor and a pushbutton at a point of entry to a drive-through portal for a vehicle, in accordance with some embodiments of the present specification;

FIG. 7B illustrates a front side perspective view of the first sensor and pushbutton at point of entry to the drive-through portal of FIG. 7A;

FIG. 8A illustrates a plan view of a path further along drive-through portal that includes a BCL sensor followed by a second sensor, in accordance with some embodiments of the present specification;

FIG. 8B illustrates a front side perspective view of radiation source and corresponding detector array, and second sensor following the point of radiation in the drive-through portal of FIG. 8A;

FIG. 9 illustrates a flow chart of an exemplary process for the function of corresponding push button status, in accordance with some embodiments of the present specification;

FIG. 10 illustrates an exemplary human machine interface (HMI), in accordance with some embodiments of the present specification;

FIG. 11 is a block diagram of an inspection system configured to inspect a cargo vehicle, in accordance with some embodiments of the present specification;

FIG. 12A is a first plan view of a cargo lane, in accordance with some embodiments of the present specification;

FIG. 12B is an elevation view of the cargo lane, in accordance with some embodiments of the present specification;

FIG. 12C is a second plan view of the cargo lane, in accordance with some embodiments of the present specification; and

FIG. 13 is a flowchart of a plurality of exemplary steps illustrating management of flow/movement of a cargo vehicle through the inspection system of FIG. 11, in accordance with some embodiments of the present specification.

### DETAILED DESCRIPTION

An efficient stationary drive-through portal should enable an operator to instruct all vehicles to pass through without requiring the driver to leave the cab, without requiring the vehicle to travel at a specific, predefined speed, and without requiring a manual initiation of X-rays. This would result in a large throughput increase. The presently described embodiments achieve these objectives by: a) having a driver remain in his/her cab as the vehicle drives through the scanning portal, b) not requiring the vehicle to travel at a specific predefined speed, and/or c) not having to independently or automatically detect the profile of a vehicle or identify a gap between the driver's cab and cargo on a real-time basis.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

For purposes of the present specification, beam center line (BCL) refers to a center of a trajectory of accelerated particles along a linear path of a LINAC, along which a beam of the accelerated particles travel.

A vehicle portal inspection system refers to a large gateway with an entrance from where a vehicle can drive (or is conveyed) through the gateway. A security inspection system is established within the gateway that is configured to inspect a vehicle's contents for contraband while the vehicle is driven through the portal/gateway. The security inspection system includes a radiation source that emits X-rays that are detected by one or more detector arrays, where the source and detectors are positioned along an inspection tunnel, also referred to as the scan tunnel, that the vehicle is driven or conveyed through. It should be appreciated that, while the radiation source is described herein as an X-ray system or LINAC, the radiation source could be any emitter of radiation, including gamma ray, neutron, photoneutron, microwave, radar, or any combination thereof.

It should be noted that the systems described throughout this specification comprise at least one processor to control the operation of the system and its components. It should further be appreciated that the at least one processor is capable of processing programmatic instructions, has a memory capable of storing programmatic instructions, and employs software comprised of a plurality of programmatic instructions for performing the processes described herein. In one embodiment, the at least one processor is a computing device capable of receiving, executing, and transmitting a plurality of programmatic instructions stored on a volatile or non-volatile computer readable medium. In embodiments, the processor is also referred to herein as a controller or a programmable logic controller (PLC) that is configured to adapt the control of the vehicle portal inspection system based on multiple parameters. The controller, as configured, is responsible for activating the LINAC to initiate a vehicle's scan.

Vehicle inspection systems are configured for inspection of one or more of cars, cargo containers, and transport vehicles of all sizes. Different sizes and types of vehicles may require different levels of radiations for inspection. Different modes for scanning are used to scan the different types of vehicles, as described previously. Low energy X-ray scan is typically used to inspect the driver's cab and passenger vehicles, and high energy X-ray scan is used to inspect the cargo. In embodiments, low energy radiation of less than 3 MeV, and high energy X-rays, between 4 and 9 MeV, are used for said scanning operations.

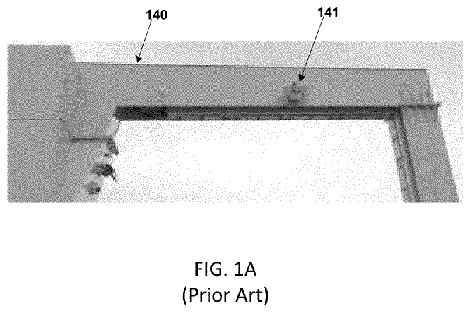

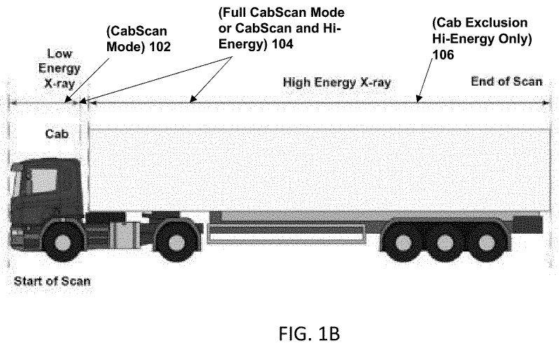

In a given vehicle portal control system, there are three modes of operation. FIG. 1B illustrates the three modes of inspection. In a first mode 102, low energy radiations are used to scan cars, buses and all low-density cargo that has no requirement for a high-energy X-ray scan. In this case, drivers are exposed to radiation and the requisite interrogating radiation is not achieved, thereby leaving portions of the cargo opaque to inspection, neither of which is acceptable. In a second mode 104, a low energy X-ray scan is applied to the driver's cab and a high energy X-ray scan is applied to the cargo. This is typically achieved using speed sensors and profiling technology, as previously described. In a third mode 106, cab portions of vehicles, which include the driver, are excluded from any type of radiations, and only the cargo portion of the vehicle is scanned with high energy X-rays. Again, this is typically achieved using speed sensors and profiling technology, as previously described.

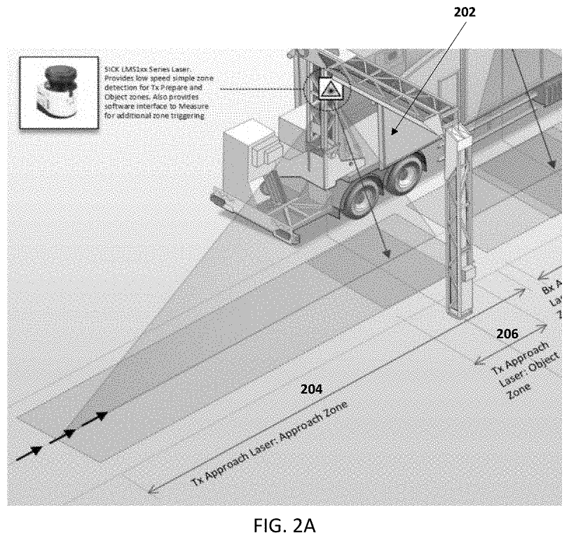

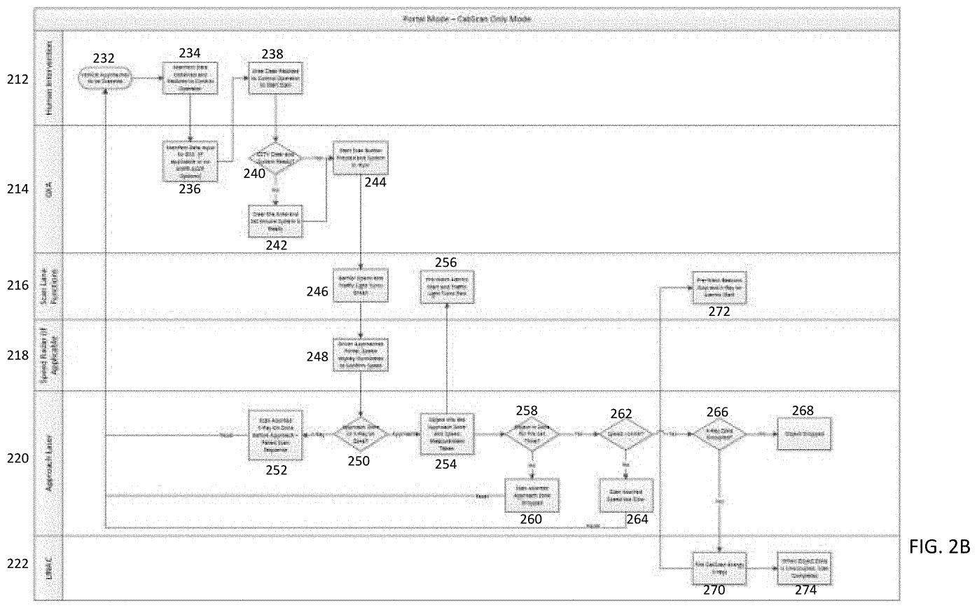

Approach lasers may be used to monitor speeds, in combination with Lidar sensors, to implement the one or more modes described above. For the first mode, the approach laser has two fields. FIG. 2A illustrates two fields used by approach laser in the first mode implementation. As a vehicle 202 approaches a predefined inspection area maintaining a speed of greater than 1 kmph, an approach laser ‘Approach Zone’ 204 is interrupted, following which an ‘Object Zone’ 206 is interrupted. Interruption of ‘Object Zone’ 206 indicates the arrival of vehicle for inspection. A controller then initiates X-rays at low energy for the entirety of the vehicle interrupting the ‘Object Zone’ 206.

FIG. 2B is a flow chart illustrating an exemplary process of generating a scan in the first mode. A first row 212 shows the points of human intervention that are required within the process. A second row 214 shows the function of a controller performed in response to the functions executed through human intervention as shown in row 212. A third row 216 shows functions performed in a scan lane in response to actions at controller shown in row 214 and data collected by an approach laser. A fourth row 218 shows the functions performed by a speed radar, which is optional. A fifth row 220 shows the operations performed by the approach laser, including detection and communication of detected data. A sixth row 222 shows the scanning operation by a LINAC, corresponding to the various operations shown in above rows. In embodiments, the process flows through the different components and persons from 212 to 222 at different stages.

Initially, at step 232 a vehicle approaches the inspection system, such as the system illustrated in FIG. 2A, and is detected by an operator. At step 234, manifest data of the vehicle is obtained and radioed to a control operator. The obtained manifest data is input to the controller at step 236, if applicable. At step 238, based on the manifest data received and checked at controller, area in the lane is declared to a control operator to be clear so that scanning may be initiated. At step 240, further automated checks are performed by the controller to determine whether a camera, such as a closed-circuit television (CCTV) and the overall inspection systems are ready for operation. If not, then at step 242, the process of clearing the area for vehicle inspection is performed and confirmed once the inspection system is ready. However, if at step 240 the CCTV is clear and the inspection system is determined to be ready, then at step 244, the scan process in initiated by activating a control such as a button associated with operating the inspection system. At this point, at step 246, a barrier in the scan lane opens while simultaneously traffic lights signal the vehicle to move forward. In embodiments, the traffic light turns green to indicate that the vehicle may move forward. At step 248, an optional, but preferred, speed radar detects an approaching vehicle driven by a driver. The driver drives towards the inspection portal in the scan lane. Optionally, a speed display illuminates to confirm the speed of the approaching vehicle.

At step 250, the approach laser detects whether the incoming vehicle is in an approach zone or an X-ray on zone. If at this point the vehicle is determined to be in the X-ray on zone, then at step 252, since the vehicle has not yet crossed the approach zone, the system identifies an error. The scan is aborted, and the system is reset to initiate the process from step 232. If however, at step 250, the vehicle is determined to be in the approach zone, then at step 254 a speed measurement is taken as soon as the vehicle reaches the approach zone. At this time, at step 256, optionally an alarm is activated to indicate upcoming activation of radiations for inspection. Additionally, the traffic lights in the scan lane turn red to signal following/trailing vehicles to stop.

At step 258, the approach laser determines whether the vehicle has been in the approach zone for at least a pre-set time. The time may be pre-set through human intervention for all vehicles, at the time of installation of the inspection system. If not, then at step 260, the scanning process is aborted, and the system is reset to re-initiate the process from step 212. Although, if the vehicle is determined to have been in the approach zone for at least the pre-set time, then at step 262, the approach laser determines vehicle's speed. If the speed is too slow, such as for example less than 1 Kmph, the process moves to step 264 where the scan is aborted and the system is reset to re-initiate the process from step 212. If the speed if appropriate (such as for example greater than 1 Kmph), then at step 266, the approach laser detects whether the X-ray zone is occupied by the approaching vehicle. If not, then at step 268, the vehicle is dropped from further process till it reaches the X-ray zone. Once the vehicle is detected to be within the X-ray zone, then at step 270, the LINAC activates a low-energy radiation. Simultaneously, at step 272, the pre-warm alarm that was activated at step 256 is stopped and a different alarm is activated that indicates an ongoing X-ray scan. The vehicle is continually moving in the approach zone and then in the X-ray zone, where it is scanned. Once the moving vehicle exits the X-ray zone, leaving the zone unoccupied, then at step 274, the scan process is complete.

The second mode is a combination of the first and third modes, where the vehicle approaches, the ‘Approach Zone’ is broken for pre-warning, the ‘X-Ray on Zone’ is broken to start low energy X-rays, followed by the end of cab laser logic to decide when to switch from low energy to high energy X-rays.

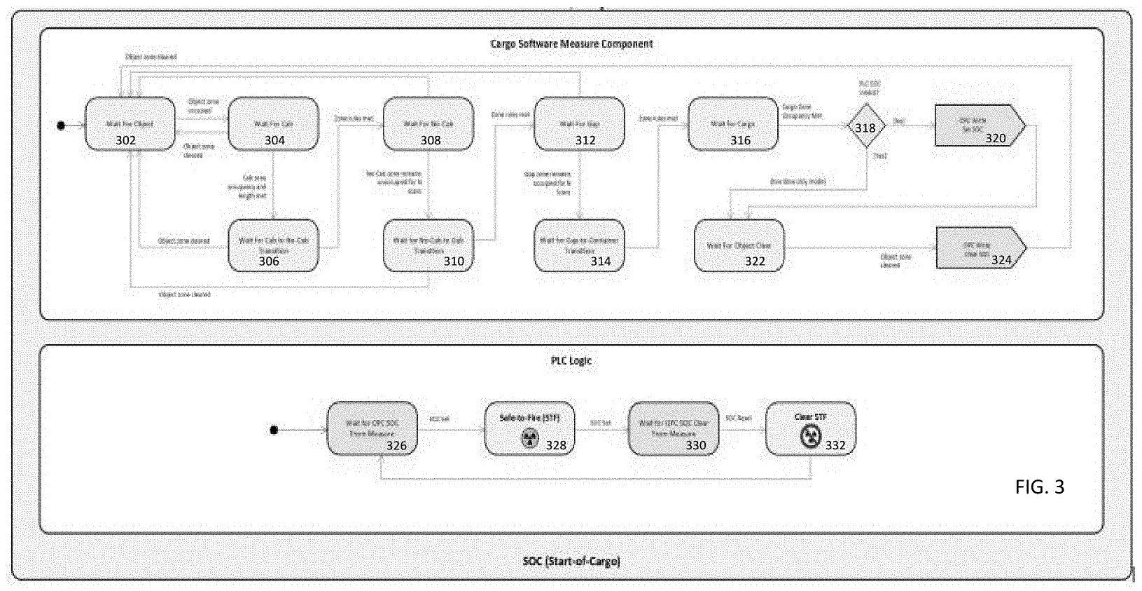

The third mode is a standard operating mode for a drive-through portal. The cab portion of the vehicle is segmented from the high energy portion of the scan. The overall methodology is the same as in the first mode, with the X-ray emission portion removed and a logic to detect end of cab (EoC) so as to determine a safe firing location. FIG. 3 is a flow chart that illustrates an exemplary method of generating scan in the third mode. The start of cargo is detected and communicated to a program logic controller (PLC) based on the following sequence being met across eight zones:

1. Object zone: Wide zone covering entire cab, gap and container area and is used to determine object occupancy in front of Linac.

2. Cab zone: Zone covers typical truck and tug cabs encompassing bonnet, roof and air dam elements. This zone incorporates a speed derived distance measurement to ensure the cab is of sufficient length.

3. Cab-to-no-cab zone: Transition zone (overlaps Cab and No-Cab).

4. No-cab zone: This is an inverted zone and will only trigger where non-occupied.

5. No-cab-to-gap zone: Transition zone (overlaps No-Cab and Gap)

6. Gap zone: Zone used to determine low parts of the truck/tug to the rear of the gab. This zone, once triggered will send the End of Cab signal to the controller.

7. Gap-to-Cargo zone: Transition zone (overlaps Gap and Cargo)

8. Cargo: Zone covers typical containerized cargo and tankers.

Referring again to FIG. 3, steps 302 to 324 are performed by a cargo software measure component, while steps 326 to 332 are performed by the PLC during Start-of-Cargo (SOC) conditions. At step 302, a wait is conducted for an object. At step 304, once the object zone is determined to be occupied, a wait is conducted for cab portion of the object. Once the cab zone occupancy and length are confirmed, at step 306, a wait is performed for cab-to-no-cab transition. At step 308, a wait is conducted for no-cab portion of the object. During this period, no-cab zone remains unoccupied for N scans. Then, at step 310, a wait is conducted for transition from no-cab to gab. Once the zone rules are met, at step 312, a wait is performed for the gap. This zone, once triggered will send an OPC EOC signal to the PLC. The gap zone may remain occupied for an N number of scans. At step 314, a wait is conducted for transition from gap to container or cargo portion of the object. Once the zone rules are met, at step 316, a wait is conducted for cargo. Once the cargo zone occupancy criteria is satisfied, a check is performed at step 318 to determine whether PLC EoC is inhibited. If not, then at step 320, OPC indicates to PLC a Start-of-Cargo (SoC). Then, the process proceeds to step 322. However, if at step 318 it is determined that PLC EoC is inhibited, then the process flows to step 322 where a wait is performed for the object to clear. Once the object zone is cleared, at step 324, OPC indicates to PLC to clear SoC.

Meanwhile, in the PLC logic, at step 326, a wait is performed for OPC to indicate SoC from cargo software measure component. Once the SoC is communicated to be set, at step 328, the PLC signals that the object is Safe-to-Fire (STF). While the SoC is still set, at step 330, the PLC continues to wait for SOC to clear from the cargo software measurement component. Once the cargo software measurement component signals clear SoC, at step 332, the PLC clears STF.

The third mode has several limitations, as described in the background section. This mode is not fail-safe for multiple reasons. First, there is a possibility of premature scanning. The laser used to detect an end of cab does not function on smaller gaps and low retroflective surfaces. Additionally, this mode does not offer an ability to direct high doses to vehicles with no gaps at all. Additionally, logic runs on Start of Cargo, potentially missing the first 20 feet (ft) of a chassis when a 20 ft container is mounted on the rear of a 40 ft chassis.

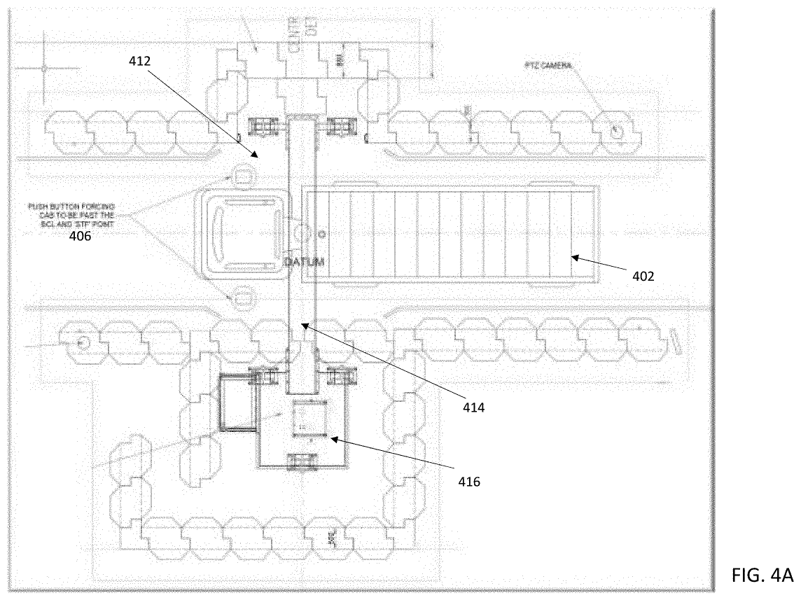

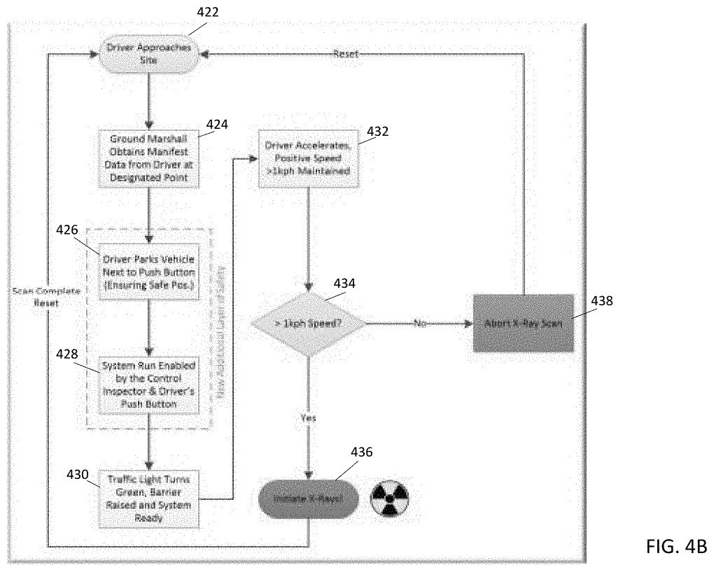

FIG. 4A illustrates an exemplary setup for inspecting a vehicle 402 in accordance with some embodiments of the present specification. FIG. 4B is a flow chart that illustrates an exemplary method of inspection using the setup of FIG. 4A, in accordance with some embodiments of the present specification. Referring simultaneously to FIGS. 4A and 4B, a driver initiated scan system and method is described, which is based on an actuator, such as a push button, 406 located on the driver's side of vehicle 402 placed after a BCL 414 of a LINAC 416. Once the actuator 406 is pushed by the driver, the system waits a predetermined period of time or monitors the vehicle for any movement (positive speed) and, once that movement is detected or the time has elapsed, initiates scanning. Since, the driver positively activates the button 406 past the beam 414, initiation of scanning is inherently safe because the driver's cab is past the BCL.

At step 422, the driver of vehicle 402 approaches an inspection site 412. At step 424, an operator appointed at site 412 obtains manifest data from the driver at a designated point. Alternatively, the manifest data may be automatically communicated from the vehicle to the portal system. At step 426, the driver of vehicle 402 drives to a safe distance past BCL 414 and stops the vehicle 402 next to button 406 thus ensuring a safe position. In embodiments, actuator 406 is placed on a spring-loaded break-away arm to reduce damage if too much force is applied. Actuator 406 could also contain hardware components such as an intercom, video camera, data entry pad for brief manifest details and/or a biometric scanner. At this point, manifest data may be collected if site 412 did not allow this to happen earlier.

At step 428, activating actuator 406 by the driver enables the operation of the system. At step 430, when the system is ready, a traffic light turns green, indicating to the driver to start driving. If there is a barrier, the barrier is also lifted to enable the driver to mover vehicle 402 forward. At step 432, the driver accelerates the vehicle 402 while maintaining a positive speed of more than 1 kmph. At step 434, the speed is detected. If it is positive and/or is more than 1 kmph, the system initiates X-ray scanning at step 436. Once the scan is complete, the system resets and the process is repeated for the next vehicle. If, however, at step 434, the speed is detected at 1 kmph or less, at step 438, the X-ray scan is aborted and the system is reset. The process is repeated for vehicle 402 if required.

The driver-initiated scan system and method provides a simple, effective and a safe inspection setup, which however, is slow. Additionally, image quality may suffer as vehicle 402 accelerates during scanning, which in-turn drives a more complex aspect ratio correction algorithm and more accurate speed measurement.

A more preferred embodiment of the present specification is directed toward safe to fire detection methods and systems that can be integrated into a portal so that high energy X-rays are only turned on once a driver of a vehicle has safely passed a beam center line of a linear accelerator, does not require detecting a gap or a vehicle profile, and does not initiate the X-ray scan while the vehicle is accelerating. Methods and systems of the present specification employ sensors for detection. In some embodiments, the sensors comprise light bar arrays. One pair of sensors is located at the entry of the portal and another pair is located beyond the beam center line in the portal, where each pair includes a transmitter and a receiver. The pairs of sensors are configured to measure distance from the front of the vehicle to the driver and determine a safe distance behind the driver to fire the high energy X-rays.

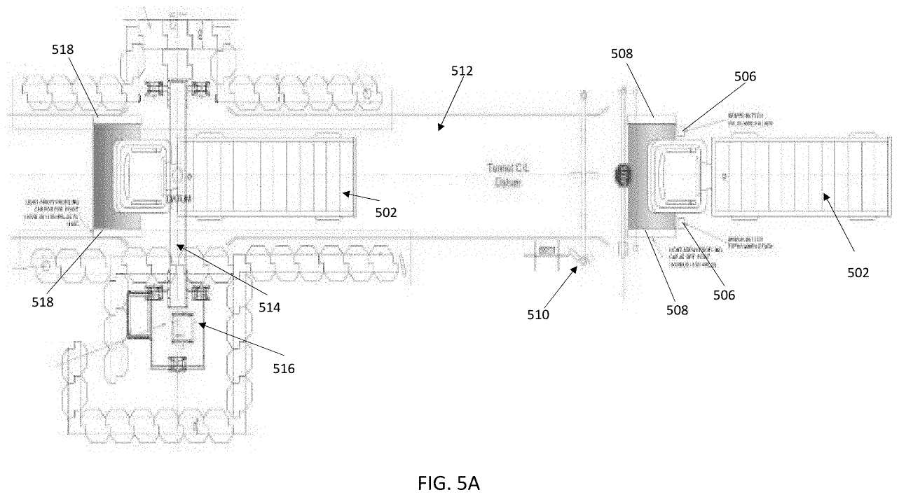

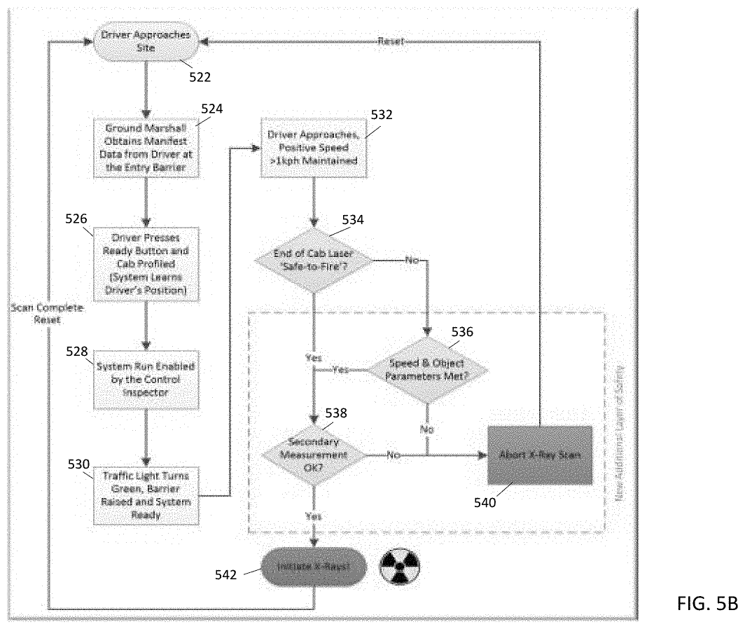

FIG. 5A illustrates an exemplary setup for inspection of a vehicle 502 in accordance with some embodiments of the present specification. FIG. 5B is a flow chart illustrating an exemplary process of inspection using the setup of FIG. 5A, in accordance with some embodiments of the present specification. Referring simultaneously to FIGS. 5A and 5B, at step 522, a driver of vehicle 502 approaches an actuator, e.g. a push button, that is positioned upstream or before the entrance of the vehicle scanning portal. A barrier may be positioned at the entry to stop vehicle 502 from actually entering the vehicle scanning portal. At step 524, an operator, such as a ground marshal, optionally obtains manifest data from the driver and/or manifest data is automatically or wireless communicated from the driver and/or vehicle to the vehicle inspection system.

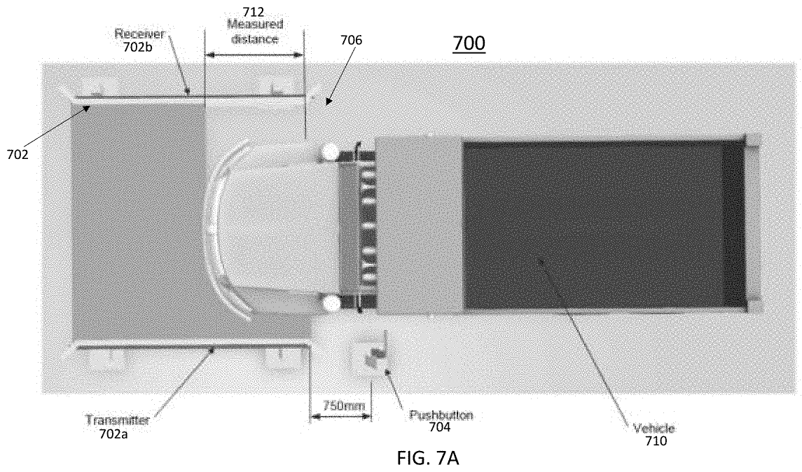

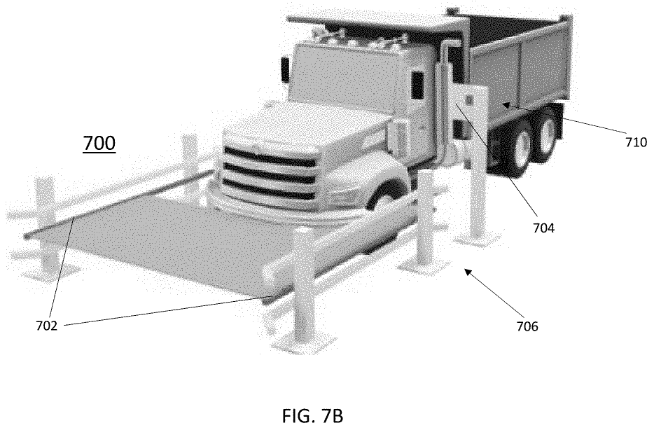

In embodiments, the actuator is provided as buttons 506 positioned on either side of the cab portion of the vehicle 502, as shown in FIG. 5A. 3At step 526, the driver interacts with the actuator, i.e. presses a button 506. At step 528, the system initiates an entry sensor array 508 to capture a profile of the cab of vehicle 502. In one embodiment, the entry sensor array 508 comprises a plurality of light emitters having a density and positioned in a range of 150 mm to 1000 mm above the ground, as further described in relation to FIGS. 7A and 7B below. The entry sensor array 508 is further positioned vertically along the path of travel of the vehicle, thereby extending from a start of the vehicle along its side to a point next to the cargo portion of the vehicle. Optionally, a control inspector appointed at the site of inspection enables the system to initiate the operation of the system. Once this is complete, and any previous scan (for example, a low-energy scan of the cab) is complete, at step 530, a traffic light 510 signals the driver to proceed with the vehicle 502. In case there is a barrier then it is lifted to enable the vehicle 502 to move forward.

At step 532, the driver approaches a scan tunnel 512 for scanning to commence, while maintaining a positive speed at more than 1 kmph. At step 534, it is determined whether the driver is at the beam center line 514 of a LINAC 516, which is the same measurement as taken previously by entry sensor array 508 plus a safety distance to reduce X-ray emission to the desired level, which is used to ensure that the driver is not exposed to the primary beam. If not, then at step 536, speed and vehicle 502 parameters are checked. In some embodiments, speed of the object (vehicle 502) is measured using Doppler radar, which is used for slow speed detection. Accordingly, at step 536, if vehicle's 502 speed falls below that of safe radiation levels for the inspection system, a safety program in the PLC of the system seizes X-ray emission for user safety purposes. The speed check ensures the driver doesn't drive through then stop in a dangerous position, where the driver is likely to be exposed to high-energy radiation. Additionally, vehicle 502 parameters may include information about the vehicle, such as and not limited to the type of vehicle, its model, dimensions, and any other vehicle-related parameters. The parameters are used in conjunction with the light bars to ensure that the vehicle 502 passing through tunnel 512 is of correct width. Checking the vehicle parameters also ensures avoiding unexpected objects, such as for example a group of people walking through tunnel 512, to inadvertently activate the system.

If at step 536 the parameters are determined to be correct, then at step 538 the system determines if the secondary measurement performed by second sensor array 518 is correct. In one embodiment, the second sensor array 518 comprises a plurality of light emitters positioned at a distance ranging from 150 to 1000 mm above the ground, as further described in relation to FIGS. 7A and 7B below. The second sensor array 518 is further positioned vertically along the path of travel of the vehicle, thereby extending from a start of the vehicle along its side to a point next to the cargo portion of the vehicle.

If the parameters are not deemed to be correct, the system aborts the scan at step 540. If the system had determined at step 536 that speed and vehicle 502 parameters are incorrect or indicate an anomaly, then also the system proceeds to step 540 to abort the scan. In case a scan is aborted, the system is reset, and the process is repeated from step 522, if required. However, if at step 538, the secondary measurement is determined to be correct, then at step 542 a high-energy scan of the cargo is commenced. The presence of the driver at the beam center line 514 and the safety distance is measured with a second sensor array 518 positioned after the beam center line 514. Measurements of the entry sensor array 508 and second sensor array 518 are compared to accurately determine that the driver is safely positioned for cargo inspection using high-energy radiations.

Embodiments of the present specification may be implemented using system components including approach laser and speed radar as described above. An EoC laser may also be included, but only the ‘Object’ zone is utilized, to ensure that the object in an inspection tunnel is a vehicle and not a human. The EoC laser is also used to end the scan (drop the object). In embodiments, the EoC laser could be replaced by ultrasonic, radar, inductive or other means to gain the ‘Object Size’ field from the EoC laser.

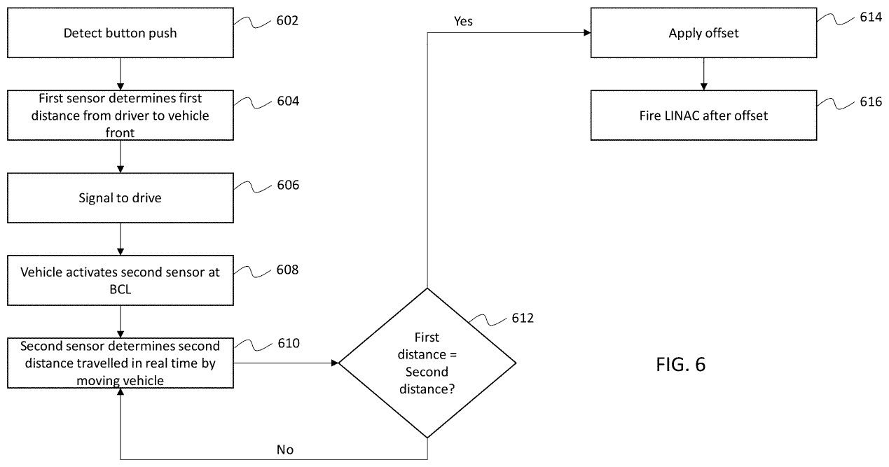

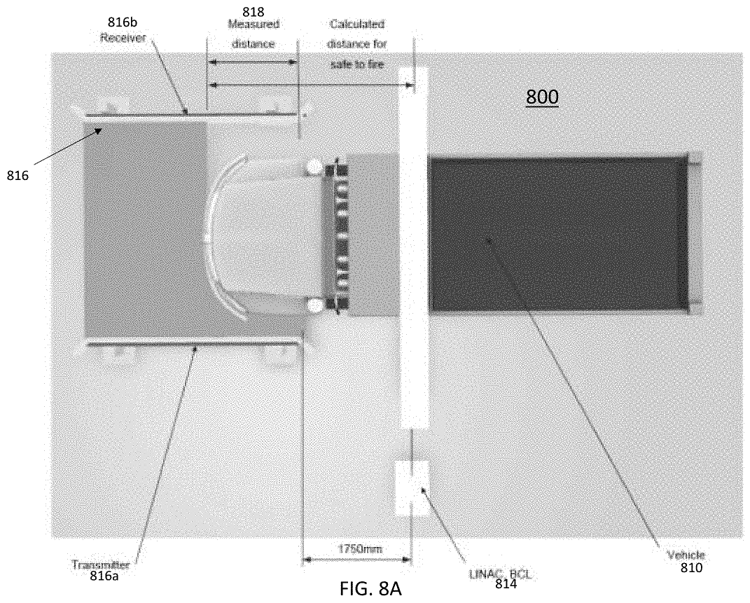

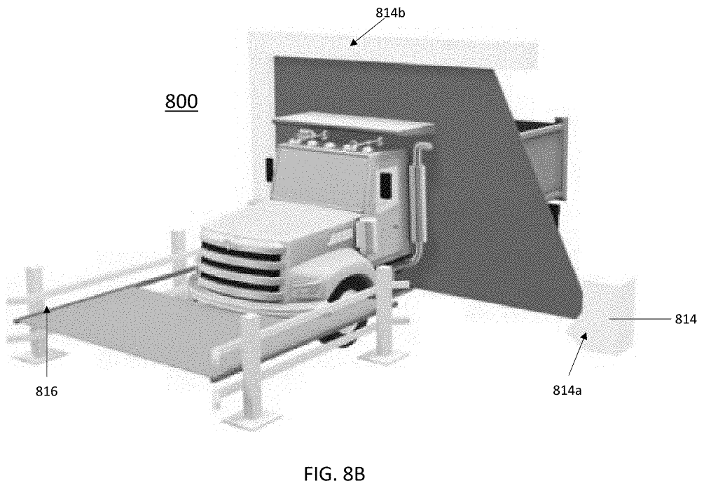

FIG. 6 is another flow chart illustrating an exemplary method of detecting a vehicle driving through a security inspection portal so that inspection radiations are activated safely after a driver of the vehicle has crossed the BCL of a LINAC. The method is further described with support of system components illustrated in FIGS. 7A to 8B. FIG. 7A illustrates a plan view of a first sensor 702 and an actuator, e.g. a push button, 704 at a point of entry 706 to a drive-through portal 700 for a vehicle 710. FIG. 7B illustrates a front side perspective view of the first sensor 702 and actuator 704 at point of entry 706 to the drive-through portal 700 of FIG. 7A.

Referring simultaneously to FIGS. 6, 7A, and 7B, at step 602, driver of vehicle 710 entering drive-through portal 700 stops to activate actuator 704 to acknowledge position of vehicle 710. In some embodiments, actuator 704 is any interface, trigger or button that may be activated by the driver to indicate presence of vehicle 710. In most drive-through inspection installations, mechanical barriers are placed around the buttons that force the driver to be at least inline, or past the point of the button, ensuring a straight or reversed arm.

In an embodiment, actuator 704 is positioned at approximately 750 millimeters (mm) before first sensor 702. It should be appreciated that the distance of actuator 704 from first sensor 702 varies based on a region. For example, in the US, where there are conventional engine-in-front designs of vehicles, the distance could be greater than 750 mm. In embodiments, the distance is determined to the minimum possible for the region, so that longer light curtains of sensor 702 are used to cover a larger range. This helps to avoid edge cases where a longer, or shorter vehicle enters and saturates the light array of first sensor 702, causing an error and no scan. First sensor 702 may include a transmitter 702a on one side of the portal 700 that transmits radiation, and a receiver 702b located opposite and parallel to transmitter 702a to sense the signals transmitted from transmitter 702a. Transmitter 702a and detector 702b are positioned at the same height from a floor. In embodiments, transmitter 702a and receiver 702b are configured on the two opposing sides of the portal 700 so that first sensor 702 extends along a length of path of travel of the vehicle 710. First sensor 702, may be positioned to the right/left of the vehicle 710, or above and below the vehicle 710. FIGS. 7A and 7B show the former embodiment where first sensor 702 is on the right/left of the vehicle 710. Further, in embodiments, sensor 702 is a light array sensor where transmitter 702a radiates light signal from a light array that is detected by corresponding array of detectors 702b. In some embodiments, transmitter 702a include an array of light emitters that transmit modulated infrared (IR) light at 850 nanometers (nm). Further, transmitter 702a and detector 702b are pulsed and coded, so detector 702b understands the light pulse received is authenticated as true. In some embodiments, sensor 702 may include other types of transmitter-receiver configurations, such as and not limited to, ultrasonic beams, microwave emitters/receivers, laser emitters/receivers, and radio frequency (RF) emitters/receivers.

Exemplary embodiments of a sensor are now briefly described. The sensor operates in a broad temperature range from −30° C. to 60° C. The sensor may have an effective detection range from 0.3 to 6 meters (m), and a threshold detection of up to 7.5 m. The sensor field height may be based on the requirement of the inspection portal, and in some embodiments is up to 3200 mm. Each light beam may be spaced at approximately 25 mm, with up to 129 beams in some cases. The number of beams may vary based on field height. In embodiments, five beams are provided for a field height of 100 mm and an overall length of transmitter/receiver unit of 260 mm, which ranges to up to 129 beams for a field height of 3200 mm and an overall length of transmitter/receiver unit of 3360 mm. In different embodiments, the beam gaps and field heights of the sensor varies based on the requirement. In various embodiments, the sensors are selected so they are immune to outdoor light conditions in which the sensors may be subject to >50,000 lux from environmental light. An example quantity/thickness/density of material required to obstruct the light beam, for detection of the material is defined by a switching threshold of the sensor arrangement. In some embodiments, about two pieces of paper, or a thickness in a range of 0.02 mm to 0.5 mm, preferably 0.1 mm to 0.2 mm, are sufficient to interrupt the light beam and trigger switching. Further, the sensor housing width is approximately 20 mm, depth is approximately 30.5 mm, and the length varies based on the requirement to up to 3360 mm. Sensor's switching command and measurement of the object (vehicle) is triggered when an object enters or is already present in the monitoring field defined between the transmitter and the receiver/detector units.

In some embodiments, one or both of actuator 704 and sensor 702 are located prior to the beginning of a scan tunnel that may be installed within the drive-through portal 700. In some other embodiments, one or both of actuator 704 and sensor 702 are located inside the scan tunnel that may be installed within the drive-through portal 700.

At step 604, first sensor 702 detects a distance 712 blocked by vehicle 710. The blocked distance 712 is recorded as indicative of a distance from a front of vehicle 710 to the driver. In an example, if the blocked distance 712 is x mm, the recorded distance from front of the vehicle to the driver who has pressed actuator 704 is the sum of x mm and 750 mm (=x+750). The recorded distance is entered into a Human Machine Interface (HMI) during commissioning of the system in accordance with the present specification.

At step 606, driver of vehicle 710 is signaled to drive through portal 700. In some embodiments, actuator 704 has an illuminated ring around it to indicate to the driver the different stages of measurement by sensor 702. In an exemplary case, the following types of ring illuminations indicate the corresponding stated measurements: off or not illuminated indicates vehicle not detected, blue indicates vehicle detected, flashing blue indicates actuator 704 is pressed and measurement is being taken, green indicates measurement taken, and red indicates presence of a fault or error in measurement. In some embodiments, the signals are displayed along the length of the path through the portal 700 so that they are visible to driver while looking in front. In embodiments, logic within a programmable logic controller (PLC) safety controller forces the first sensor 702 to see a minimum number of beams to be broken in a sequence to ensure the vehicle 710 has entered and stopped. Actuator 704 is held for at least three seconds while the PLC gets a reliable reading prior to allowing the driver to continue. At this point, the PLC monitors to see that a steady rise to maximum and fall to minimum is seen to ensure the driver enters the system properly.

Once the signal is received at step 606, driver of vehicle 710 continues to drive through portal 700. FIG. 8A illustrates plan view of a path further along drive-through portal 700/800 that includes a BCL sensor 814 followed by a second sensor 816. BCL sensor 814 is a part of a LINAC radiation detection system forming a point of radiation, that includes a radiation source 814a on one side of portal 800 and a corresponding array of detectors 814b on opposite receiving sides of portal 800. FIG. 8B illustrates a front side perspective view of radiation source 814a and corresponding detector array 814b, and second sensor 816 following the point of radiation in the drive-through portal 800 of FIG. 8A. In some embodiments, BCL sensor 814 is positioned at approximately 1750 millimeters (mm) before second sensor 816. Second sensor 816 may include a transmitter 816a on one side of the portal 800 that transmits radiation, and a receiver 816b located opposite and parallel to transmitter 816a to sense the signals transmitted from transmitter 816a. In embodiments, transmitter 816a and receiver 816b are configured on the two opposing sides of the portal 800 so that second sensor 816 extends along a length of path of travel of vehicle 810 (vehicle 710 of FIGS. 7A and 7B). Second sensor 816, may be positioned to the right/left of the vehicle 810, or above and below the vehicle 810. The illustrations of FIGS. 8A and 8B show the former embodiment where second sensor 816 is on the right/left of vehicle 810. Further, in embodiments, sensor 816 is a light array sensor where transmitter 816a radiates light signal from a light array that is detected by corresponding array of detectors 816b. In some embodiments, sensor 816 may include other types of transmitter-receiver configurations, such as and not limited to, ultrasonic beams, microwave emitters/receivers, laser emitters/receivers, and radio frequency (RF) emitters/receivers. Embodiments of sensor 816 are similar to embodiments described previously for sensor 702.

Referring simultaneously to FIGS. 6, 8A, and 8B, at step 608, vehicle 810 drives through portal 800 and activates second sensor 816. At step 610, second sensor 816 determines a second distance (y) 818 travelled in real time by moving vehicle 810. The system continually takes measurements in real time using second sensor 816 to determine how far past the BCL sensor 814 has the driver travelled.

At step 612, the two distances—first measured distance (x) 712 at the point of entry and second distance (y) 818 measured in real time—are compared. When x is determined to be equal to y, then at step 614, an offset is applied to the distance measured by second sensor 816. At step 616, LINAC is activated to fire radiation from source 816a to initiate the inspection of cargo carried by vehicle 810. The offset is a distance that may be defined by an operator or a user of system and method of present specification. The offset is added to the distance (y, now equal to x) 818 measured by the second sensor 816, so that the LINAC is fired for safe inspection of cargo after the driver has crossed BCL sensor 814. In an exemplary embodiment, where BCL sensor 814 is positioned at approximately 1750 millimeters (mm) before second sensor 816, an offset of 1750 mm may be used. In the example, the measurement recorded by system of the present specification is a sum of second distance (y) 818 and 1750 mm. Thus, when the distance from front of vehicle 810 to BCL sensor 814 is (y+1750) mm, at which distance the driver has safely crossed the BCL sensor, the LINAC can be fired. The offset distance, and distance from BCL sensor 814 to second sensor 816 (1750 mm in the example given) is also entered into the HMI during commissioning of the system in accordance with the present specification. In various embodiments, the offset distance is different for different systems, and may be in a range of 1750 mm to 2500 mm. In some embodiments, the offset distance is variable for a system, and is automatically furnished based on detection of vehicle parameters, such as for example the model of vehicle 710/810, which may be identified from vehicle's 710/810 license plate.

A controller, including a computing system, is integrated with first and second sensors 702, 816, BCL sensor 814, actuator 704, the HMI, and the overall LINAC inspection system of drive-through portal 700/800 that controls the operation of the sensors according to the type of vehicle 710/810, the sensors and sensor positions. The controller enables modification of the offset for different types of drive-through portals and based on the kind of vehicles passing through the portals. In an example, vehicles with sleeper cabins have a greater offset than compact trucks. The offset may also account for the fact the driver may not be exactly next to pushbutton 704. The controller may also be in communication with one or more optical cameras that capture each vehicle's profile and identifying markers such as its license plate, with its reference signal to create a vehicle profile. Here, the reference signal relates to offset distance after the driver when high energy radiations are activated. In an alternative embodiment, the controller may correlate the first distance and the license plate identification to determine a type/form/model of a vehicle and therefore calculate an offset specifically for that vehicle.

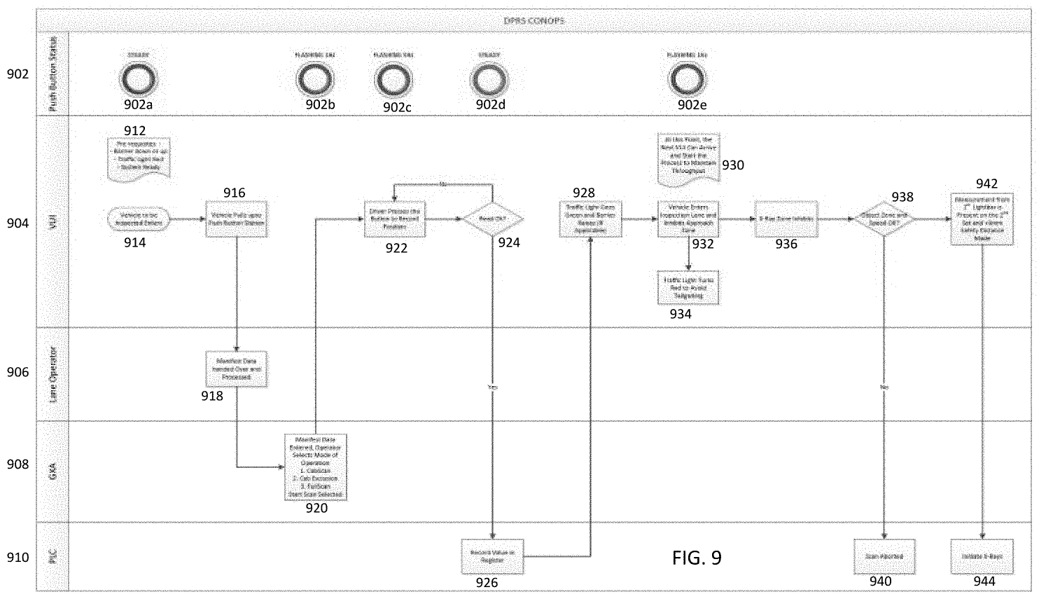

FIG. 9 illustrates a flow chart of an exemplary process for the function corresponding actuator 704 status, in accordance with some embodiments of the present specification. A first row 902 shows the different status of push button 704, which is indicated in some embodiments, by a light signal that encircles the button 704. A second row 904 shows the actions associated with a Vehicle Under Inspection (VUI), corresponding to the status changes of button 704 signaled in first row 902. A third row 906 shows the operation of a lane operator, in response to the status of button 704, as indicated in first row 902. A fourth row 908 shows the function of a GXA performed in response to the functions executed by the lane operator as shown in row 906. A fifth row 910 shows the steps executed by a PLC, corresponding to the various operations shown in above rows. In embodiments, the process flows through the different components and persons from 902 to 910 at different stages.

During an initial stage, button has a steady status 902a, which may be indicated by a red colored light encircling the button. At this stage, pre-requisites 912 are applicable, which include: a barrier at the entry is either up or down, traffic light signal is red indicating an incoming vehicle to stop; and system is ready. At step 914, a vehicle enters a lane corresponding to the inspection system, for inspection. At step 916, the vehicle pulls up to the actuator station. In some cases, at step 918, a lane operator collects and processes manifest data that is handed over by the driver. Once the manifest data is handed and processed, the actuator status changes to a flashing status 902b. During status 902b, at step 920, manifest data is entered at GXA 908, and an operator selects a mode of operation. The mode may be one of the three modes described previously, which include cab scan, full scan of the vehicle, and a scan that excludes the cab portion to inspect only the cargo portion of the vehicle. Additionally, the selected scan process is initiated at step 920. Following the initiation, at step 922 the actuator changes status to flashing at a different frequency (status 902c), when the driver of the vehicle presses the actuator at the station to record the vehicle's position. The vehicle's position is recorded by a first set of sensors, as described earlier in context of FIG. 6.

At step 924, the system determines whether the actuator activation by the driver is accurately recorded. The system continues to determine accurate actuator activation till it is complete. At step 926, the recorded value is registered by the PLC 910. At this stage, status of the actuator changes to status 902d, which may be indicated with a green colored light signal. At step 928, the traffic light signal visible to the driver is changed to a green color to indicate the driver to move forward. In case a barrier was in place, it is also removed or lifted at this stage. At step 932, the vehicle moves forward to enter the inspection lane and inhibits approach zone. At this point, the light signal around the button changes itself to a status 902e. In some embodiments, the signal changes again to a flashing blue light. Now (noted at 930), next vehicle may arrive and start the process from the beginning to maintain throughput. Additionally, at step 934, traffic light signal visible to the driver of the next vehicle turns red, indicating the next vehicle to stop to avoid tailgating.

The first vehicle that has entered the inspection lane moves forward to inhibit X-ray zone, at step 936. At step 938, the system determines whether object zone position and speed of the vehicle are acceptable. If not, the PLC aborts the scan at step 940. If at step 938, the parameters are determined to be acceptable, then at step 942, the vehicle keeps moving while measurement from the first set of sensors is achieved by the second set of sensors and a safety distance is additionally travelled. At step 944, the PLC initiates high energy X-ray scan of the remainder of the vehicle.

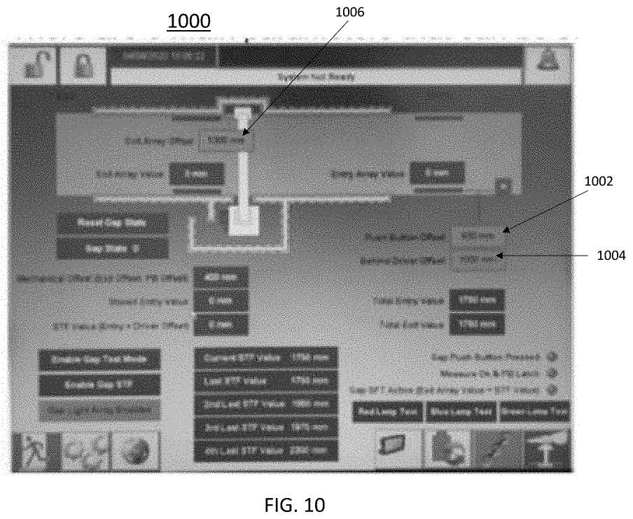

FIG. 10 illustrates an exemplary HMI 1000, in accordance with some embodiments of the present specification. At least three parameters may be set by a user or operator using the HMI 1000. These include: a Push Button Offset 1002, a Behind Driver Offset 1004, and an Exit Array Offset 1006. Push Button Offset 1002 is the physical distance from the entry pushbutton (704 of FIGS. 7A and 7B) to the first measuring beam of the entry light array (first sensor 702 of FIGS. 7A and 7B) and is a constant once set. In the example described earlier, the push button offset is 750 mm. Behind Driver Offset 1004 is the distance behind the driver of vehicle 710/810 where the high energy x-ray beam of LINAC should be turned on. In the above example, this offset of 1000 mm. Exit Array Offset 1006 is the physical distance from the high energy x-ray beam line (BCL sensor 814 of FIGS. 8A and 8B) to the first measuring beam on the exit light array (second sensor 816 of FIGS. 8A and 8B) and is constant once set. In the above example, this offset is set at 1750 mm.

Embodiments of the present specification are designed to replace a universal automated approach to detecting end of a driver's cab in a vehicle, by creating a reference signal tailored to each specific vehicle. Additionally, embodiments of the present specification do not require a speed sensor to track the speed of the vehicle driving through the inspection portal. Further, the embodiments allow a vehicle to travel within a range of speeds and not have to travel at one specific speed. An exemplary range of speeds may be within 3 kilometers per hour (km/hr) to 8 km/hr.

Additionally, while embodiments of the present specification are disclosed in terms of a single lane drive-through security inspection system, the embodiments can be expanded to enable multiple lanes equipped with multiple sensors sets, for higher throughput of traffic. In some embodiments, each lane is configured with a light curtain that is used to measure vehicle speed as it enters the lane.

When compared with the traditional measurement methods and systems such as those using Lidar, embodiments of the present specification take all the elements of potential error away to measure a point of a vehicle in relation to the driver's position. The measured value is replicated at the X-ray beam line and a safety offset is added to ensure fail-safe scanning of high-energy X-rays. Embodiments of the present specification allow all vehicle types irrespective of shape, color, and size to be safely scanned without compromising throughput or safety.

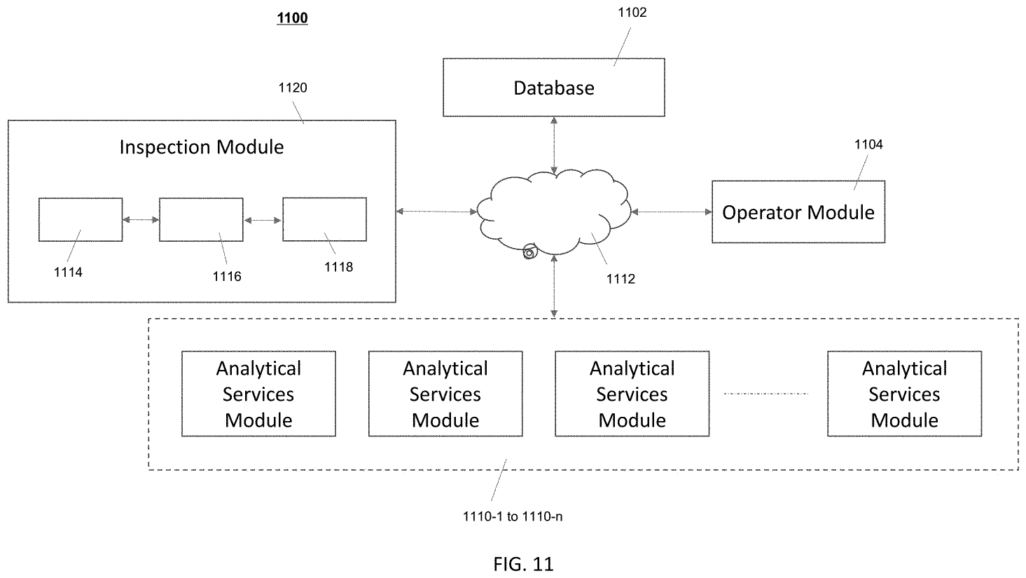

FIG. 11 is a block diagram of an inspection system 1100 configured to inspect a cargo vehicle, in accordance with some embodiments of the present specification. In some embodiments, the system 1100 comprises a database 1102, an inspection module 1120 configured to non-intrusively inspect the cargo vehicle and generate an integrated data packet or structure, at least one operator module 1104 and a plurality of analytical services modules 1110-1 to 1110-n. In some embodiments, modules 1102, 1104, 1110-1 to 1110n and 1120 are in data communication with one another over a wired and/or wireless network 1112 (such as the Internet/Intranet).

In accordance with aspects of the present specification, each of the plurality of analytical services modules 1110-1 to 1110-n represents programmatic code or instructions (executing on a third party platform, for example) configured to extract one or more data from the integrated data packet or structure for processing and analysis and thereby generate an outcome or result indicative of release or detention of the cargo vehicle from the inspection system 1100. Stated differently, each of the plurality of analytical services modules 1110-1 to 1110-n is a fully containerized micro-service that, when called upon and applied to the integrated data packet or structure, performs a specialized and specific function. For example, if an operator (of the at least one operator module 1104) determines that the integrated data packet or structure pertains to a specific type of cargo (such as, for example, coffee beans) then the operator may access and apply an analytical service module to the integrated packet or structure where the analytical service module is developed by, as an example, Brazilian customs. In another example, the operator may access and apply another analytical service module (developed by for example, the US customs) specialized in identifying a gun in a handbag with low false alarm rates. In some embodiments, each of the plurality of analytical services modules 1110-1 to 1110-n may be hosted by a third party platform that executes the associated analytical service in a predefined native format.

In some embodiments, the inspection module 1120 includes a traffic control system (TCS) 1114, an identification and monitoring system 1116 and a scanning unit 1118. In some embodiments, the scanning unit 1118 is configured as a drive-through, multi-energy X-ray scanning unit capable of generating scan image data and material characterization data of the cargo vehicle that is driven through the scanning unit. In some embodiments, the scanning unit 1118 further includes an integrated under vehicle back-scatter system (UVBS). In some embodiments, the scanning unit 1118 also includes an integrated radiation scanning portal configured to screen the cargo vehicle for fissile material.

In some embodiments, the integrated data packet or structure includes X-ray scan image data and material characterization data of the cargo vehicle as well as metadata such as, but not limited to, manifest or shipping data (which may be pre-stored in and acquired from the database 1102); an average speed of the cargo vehicle during scanning; optical image data; video data; cargo vehicle classification data; biometrics data to identify one or more occupants of the cargo vehicle; and/or identification data such as, for example, RFD (Radio Frequency Identification) data, QR code data and license plate data (or container number Optical Character Recognition (OCR) data for sea cargo containers).

In some embodiments, the integrated data packet or structure is communicated from the inspection module 1120 to the at least one operator module 1104 in real-time while concurrently being stored in the database 1102. In some embodiments, the integrated data packet or structure is stored in the database 1102 for further access and retrieval by the at least one operator module 1104.

In embodiments, the operator module 1104 is configured to a) generate at least one graphical user interface (GUI) and receive operator instructions to acquire stored integrated data packet or structure from the database 1102 and/or real-time integrated data packet or structure from the inspection module 1120, b) enable the operator of the operator module 1104 to determine and select an analytical services module, from the plurality of analytical services modules 1110-1 to 1110-n, that should be applied to the integrated data packet or structure, c) apply an abstracted application program interface specific to the predefined native format of the selected analytical services module in order to enable the associated analytical service to be applied to the integrated data packet or structure, d) track and capture the operator's date and time stamped interactions with the information content of the integrated data packet or structure accessed through the at least one GUI, and e) integrate the tracked and captured date and time stamped interactions into the integrated data packet or structure. In some embodiments, the operator's date and time stamped interactions are tracked and captured via the operator's use of human machine interfaces (such as, the at least one GUI, mouse usage, keyboard keystrokes) and using at least one camera to determine what the operator is doing at the operator module 1104 based on tracking of the operator's eye movements using the camera.

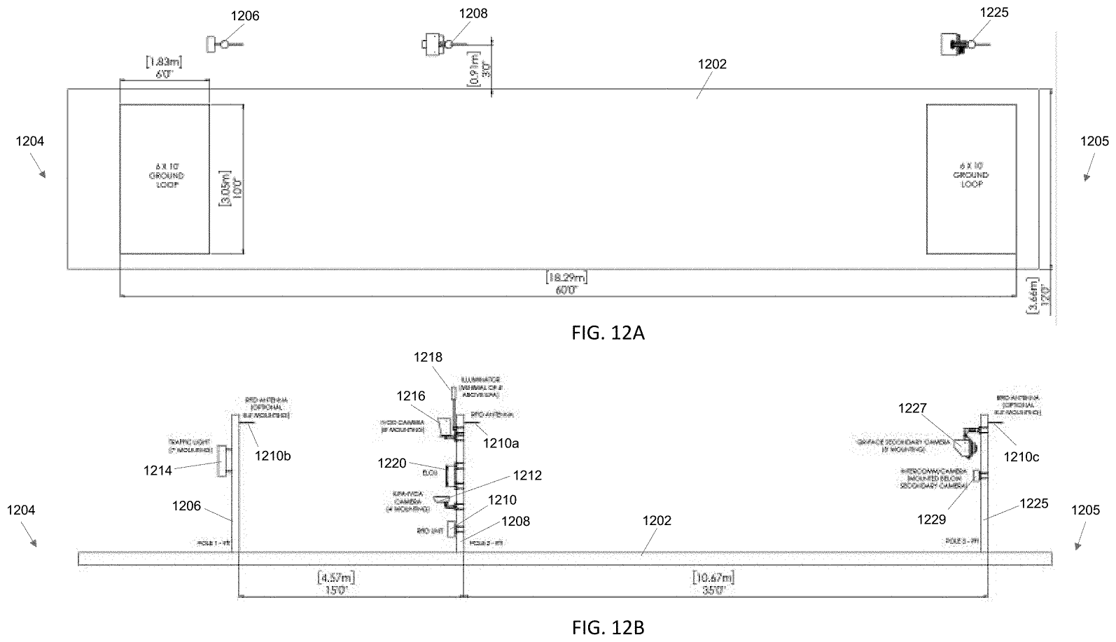

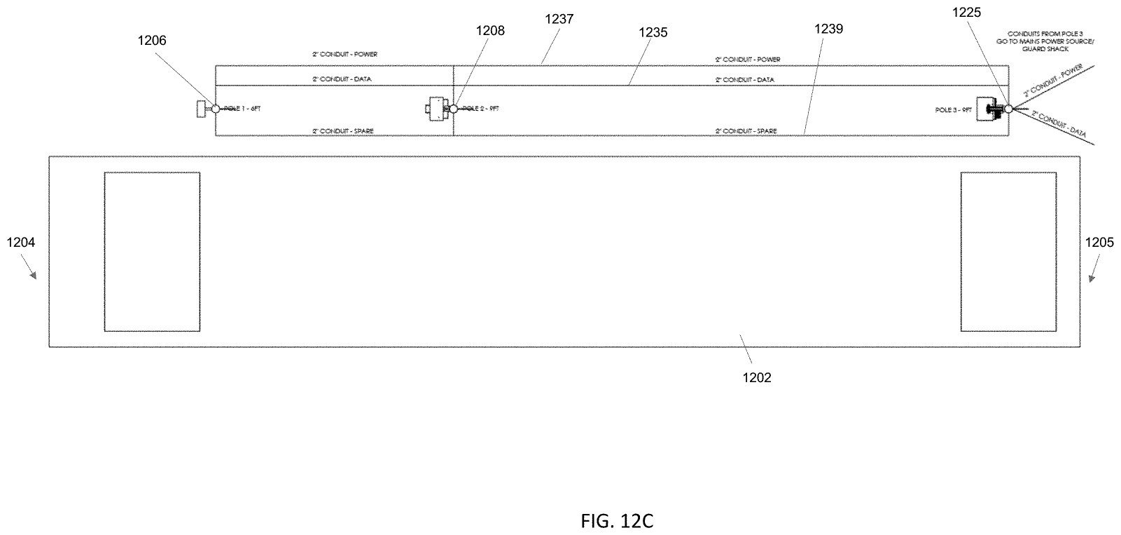

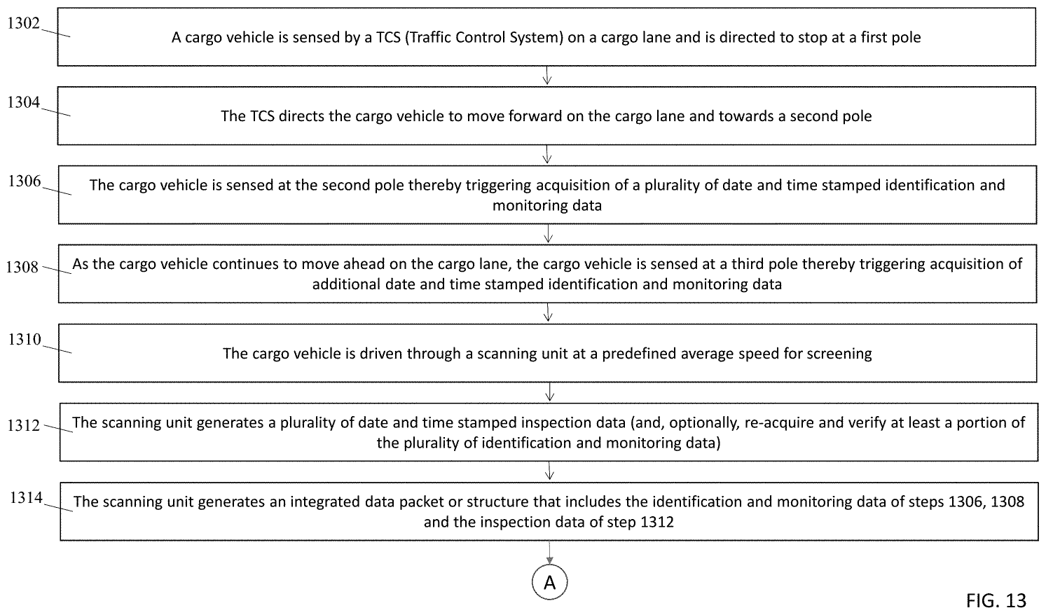

FIGS. 12A and 12B are plan and elevation views, respectively, of a cargo lane 1202 while FIG. 12C is another plan view of the cargo lane 1202, in accordance with some embodiments of the present specification. Referring now to FIGS. 11, 12A through 12C, the cargo lane 1202 enables the cargo vehicle to enter the lane 1202 from a first side 1204 and be driven into and through the drive-through scanning unit 1118 (not shown in FIGS. 12A through 12C) at a second side 1205. In accordance with an embodiment, the TCS 1114, the identification and monitoring system 1116 and the scanning unit 1118 are installed along the cargo lane 1202.

As shown, the TCS 1114 includes at least one group of traffic lights 1214 positioned on a first pole 1206 that is configured as a first check-in kiosk. The traffic lights 1214 function as a first control point directing the cargo vehicle when to move towards the scanning unit 1118. The traffic lights 1214 includes at least a “red” light indicative to the cargo vehicle to stop and a “green” light indicative to the cargo vehicle to move forward on the cargo lane 1202. In some embodiments, the TCS 1114 includes sensors, at the first pole 1206, that detect presence of the cargo vehicle approaching the first pole 1206 and trigger the “green” light when the cargo lane 1202 is clear for the cargo vehicle to proceed towards the scanning unit 1118. It should be appreciated that the TCS “red” light is enabled behind the cargo vehicle moving towards the scanning unit 1118 to stop a next cargo vehicle at the first pole 1206.

As the cargo vehicle moves past the first pole 1206 it approaches a second pole 1208 that is positioned at a predefined distance from the first pole 1206. The second pole 1208 is configured as a second check-in kiosk. The second pole 1208 has a plurality of elements of the identification and monitoring system 1116 such as, for example, an RFID reader 1210, a first RFID antenna 1210a, a first camera 1212, a second camera 1216, an illuminator 1218 (such as an LED, halogen or any other fog lamp) and an emergency light control unit (ELCU) 1220. The second pole 1208 includes sensors that detect the presence of the cargo vehicle and triggers the elements of the identification and monitoring system 1116. The first RFID antenna 1210a and RFID reader 1210 are configured to read an RFID tag on the cargo vehicle and acquire RFID data associated with the cargo vehicle. The first camera 1212 is configured to capture optical images and/or video of front and rear license plates of the cargo vehicle (front and rear license plates of truck and trailer when the cargo vehicle includes a truck portion and a trailer). The optical images and/or videos are analyzed by associated license plate and vehicle classification analytics in order to generate license plate data and vehicle classification data in real-time. In some embodiments, the license plate and vehicle classification analytics include machine learning and image processing algorithm(s) to accurately provide license plate data including plates alpha-numeric value, country, state of origin and vehicle classification data including the make, model, and color of the cargo vehicle. Systems and methods for license plate and vehicle classification analysis are similar to those disclosed in U.S. Pat. No. 10,867,193, entitled “Imaging Systems for Facial Detection, License Plate Reading, Vehicle Overview and Vehicle Make, Model, and Color Detection” and issued on Dec. 15, 2020, and United States Patent Application Publication Number US 2021-0097317 A1, of the same title and published on Apr. 1, 2021, both of which are hereby incorporated by reference in their entirety.

The second camera 1216 is configured to capture optical images and/or video of the cargo vehicle that are analyzed by associated vehicle occupant detection analytics in order to perform real-time facial detection and recognition of all vehicle occupants (both front and rear seats) under a variety of challenging conditions including day, night, inclement weather, high-glare sunlight, and through heavily tinted glass. Thus, the vehicle occupant detection analytics generate vehicle occupants' biometrics data. Systems and methods for facial detection and recognition are similar to those disclosed in U.S. Pat. No. 9,953,210, entitled “Apparatus, Systems and Methods for Improved Facial Detection and Recognition in Vehicle Inspection Security Systems” and issued on Apr. 24, 2018, and U.S. Pat. No. 10,657,360, of the same title and issued on May 19, 2020, both of which are hereby incorporated by reference in their entirety.

In some embodiments, low-dose radiographic imaging systems are used, similar to those disclosed in: U.S. Pat. No. 8,971,485, entitled “Drive-Through Scanning Systems” and issued on Mar. 3, 2015; U.S. Pat. No. 9,817,151, of the same title and issued on Nov. 14, 2017; U.S. Pat. No. 10,754,058 and issued on Aug. 25, 2020; United States Patent Application Publication Number 2021-0018650 A1, of the same title and published on Jan. 21, 2021; U.S. Pat. No. 8,903,046, entitled “Covert Surveillance Using Multi-Modality Sensing” and issued on Dec. 2, 2014; U.S. Pat. No. 9,632,205, of the same title and issued on Apr. 25, 2017; U.S. Pat. No. 10,408,967, of the same title and issued on Sep. 10, 2019; U.S. Pat. No. 10,942,291, of the same title and issued on Mar. 9, 2021; U.S. Pat. No. 11,307,325, of the same title and issued on Apr. 19, 2022; and, U.S. Pat. No. 9,218,933, entitled “Low-Dose Radiographic Imaging System” and issued on Dec. 22, 2015, all of which are hereby incorporated by reference in their entirety.

As the cargo vehicle moves past the second pole 1208, it approaches a third pole 1225 that is positioned at a predefined distance from the second pole 1208. In embodiments, the third pole 1225 is configured as a third check-in kiosk.

Third pole 1225 includes a plurality of additional elements from identification and monitoring system 1116 such as, for example, a first element 1227 and a second element 1229. In some embodiments, the first element 1227 includes at least one of a QR code reader and a camera with associated facial detection and recognition analytics. In embodiments, the first element 1227 generates QR code data and verifies vehicle occupants' biometric data that was generated at the second pole 1208 (additionally, this functions as a redundant camera to capture biometric data in case the second camera 1216 fails to do so positively). In some embodiments, the second element 1229 includes yet another camera and/or Intercom. In some embodiments, the second element 1229 is mounted below the first element 1227.

In some embodiments, a total length of cargo lane 1202 is in a range of 15 to 25 meters. In some embodiments, a total length of cargo lane 1202 is 18.29 meters. In some embodiments, a first length from the first pole 1206 to the second pole 1208 is in a range of 2.50 to 7.50 meters. In some embodiments, a first length from the first pole 1206 to the second pole 1208 is 4.57 meters. In some embodiments, a second length from the second pole 1208 to the third pole 1225 is in a range of 5 to 15 meters. In some embodiments, a second length from the second pole 1208 to the third pole 1225 is 10.67 meters. In some embodiments, a width of the cargo lane 1202 is in a range of 2 to 6 meters. In some embodiments, a width of the cargo lane is 3.66 meters.

In some embodiments, additional second and third RFID antennas 1210b, 1210c are optionally installed on the first and third poles 1206, 1225 respectively. Also, as shown in FIG. 12A, the first, second and third poles 1206, 1208, 1225 are positioned along a side of the cargo lane 1202 and at a predefined distance from the side of the cargo lane 1202.

Referring now to FIG. 12C, a first conduit 1235 for a data line, a second conduit 1237 for a power line and a third conduit 1239 connect the first, second and third poles 1206, 1208, 1225. In some embodiments, the first, second and third conduits 1235, 1237, 1239 are installed underground along the side of the cargo lane 1202.

Beyond the third pole 1225, the cargo vehicle enters the scanning unit 1118 (FIG. 11) (at a predefined average speed) that generates X-ray scan image data and material characterization data of the cargo vehicle. In some embodiments, additional data such as under-vehicle backscatter (UVBS) image data and radiation screening data may also be generated. In some embodiments, the following plurality of data is packaged into an integrated data packet or structure and communicated to the operator module 1104 and the database 1102 over the network 1112 in real-time: X-ray scan image data, UVBS image data, radiation data, material characterization data, vehicle average speed data (during scanning), as well as identification and monitoring data including optical image data, video data, cargo vehicle classification data, biometrics data identifying one or more occupants of the cargo vehicle, RFID data, QR code data and license plate data.

After scanning, the TCS 1114 directs the cargo vehicle to a staging lane where the cargo vehicle awaits a signal indicative of being “cleared” or “detained” for violation or detection of contraband. If “detained”, the TCS 1114 directs the cargo vehicle to a secondary warehouse or location for further processing and investigation.

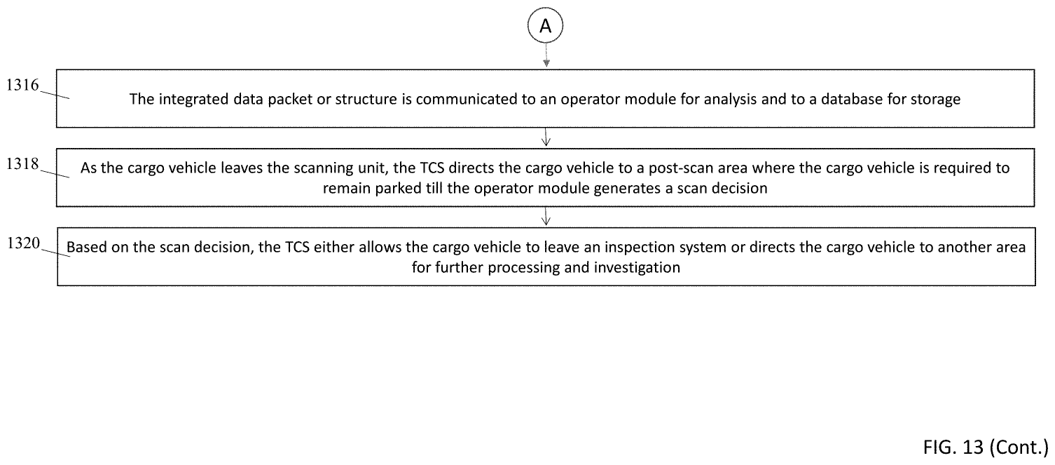

FIG. 13 is a flowchart of a plurality of exemplary steps illustrating management of flow/movement of a cargo vehicle through the inspection system 1100 (FIG. 11), in accordance with some embodiments of the present specification. Referring now to FIGS. 11, 12A through 12C and 13, at step 1302, the cargo vehicle is sensed by the TCS 1114 on the cargo lane 1202 and directed to stop at the first pole 1206 (that is, at the first check-in kiosk or point). In some embodiments, prior to approaching the first pole 1206, the cargo vehicle is screened for oversize and diverted if required else the cargo vehicle approaches the first pole 1206 at step 1302.

At step 1304, the TCS 1114 directs the cargo vehicle to move forward on the cargo lane 1202 and towards the second pole 1208. At step 1306, the cargo vehicle is sensed at the second pole 1208 (that is, at the second check-in kiosk or point) thereby triggering acquisition of a plurality of date and time stamped identification and monitoring data such as, for example, optical image data, video data, cargo vehicle classification data, biometrics data identifying one or more occupants of the cargo vehicle, RFID data, and license plate data (front and rear).

At step 1308, as the cargo vehicle continues to move ahead on the cargo lane 1202, the cargo vehicle is sensed at the third pole 1225 (that is, at the third check-in kiosk or point) thereby triggering acquisition of additional date and time stamped identification and monitoring data such as, for example, QR code data, re-acquisition of biometrics data associated with one or more occupants of the cargo vehicle.

At step 1310, the cargo vehicle is driven through the scanning unit 1118 at a predefined average speed for screening. At step 1312 the scanning unit 1118 generates a plurality of date and time stamped inspection data such as, for example, X-ray scan image data, UVBS image data, radiation data, material characterization data, vehicle average speed data (during scanning), scanning unit ID and a unique identification or case record number. In some embodiments, the scanning unit 1118 may optionally be equipped with additional sensors to re-acquire and verify at least a portion of the plurality of identification and monitoring data that was acquired in steps 1306 and 1308.

At step 1314, the scanning unit 1118 generates an integrated data packet or structure that includes the identification and monitoring data of steps 1306, 1308 and the inspection data of step 1312. At step 1316, the integrated data packet or structure is communicated (in real-time) to the operator module 1104 for analysis and to the database 1102 for storage. In some embodiments, the operator module 1104 selects at least one of the plurality of analytical services modules 1110-1 to 1110-n to apply to the integrated data packet or structure to enable the operator to analyze and determine if the cargo vehicle should be “cleared” or “detained” for violation or detection of contraband.

At step 1318, as the cargo vehicle leaves the scanning unit 1118, the TCS 1114 directs the cargo vehicle to a post-scan area, waiting or staging lane where the cargo vehicle is required to remain parked till the operator module 1104 generates a scan decision. At step 1320, based on the scan decision, the TCS 1114 either allows the cargo vehicle to leave the inspection system 1100 or directs the cargo vehicle to another area for further processing and investigation.

The above examples are merely illustrative of the many applications of the methods and systems of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A system for cargo inspection of a vehicle using high energy radiations, the system integrated with a drive-through inspection portal comprising a point of entry followed by a point of radiation, the system comprising:
a first sensor located after the point of entry, to detect a first distance blocked by the vehicle at the point of entry;
a second sensor to detect a second distance blocked by the vehicle in real time as the vehicle drives through the portal from the point of entry towards the point of radiation, wherein the second sensor is located after the point of radiation; and
a controller to compare the second distance and the first distance, and apply an offset once the second distance equals the first distance, wherein the controller triggers the high energy radiations at the vehicle after the offset.

2. The system of claim 1 wherein the first and the second sensors each comprise at least one of a light array, an ultrasonic beam, microwave emitters and receivers, laser emitters and receivers, and radio frequency (RF) emitters and receivers.

3. The system of claim 1 wherein the point of entry comprises a button, wherein the first sensor performs the detection when the button is activated by a driver of the vehicle.

4. The system of claim 3 wherein the button is a push button.

5. The system of claim 3 wherein the button is at least 750 mm before the first sensor.

6. The system of claim 1 wherein the first distance represents a distance from a front of the vehicle to a driver of the vehicle.

7. The system of claim 1 wherein the point of radiation comprises a beamline center of a linear accelerator.

8. The system of claim 1 wherein the second sensor is at least 1750 mm after the point of radiation.

9. The system of claim 1 wherein the offset is defined by a user operating the controller.

10. The system of claim 1 wherein the offset is a distance if at least 1000 mm.

11. The system of claim 1 further comprising at least one optical camera to capture the vehicle's profile and identifying markers to create a vehicle profile.

12. A method for cargo inspection of a vehicle using high energy radiations within a drive-through inspection portal comprising a point of entry followed by a point of radiation, the method comprising:
detecting activation of a button by a driver of the vehicle at the point of entry;
measuring a first distance by a first sensor positioned after the button, wherein the first distance is indicative of a distance from a front of the vehicle to the driver;
measuring a second distance by a second sensor positioned after the point of radiation, wherein the second distance is measured in real time as the vehicle moves through the portal from the point of entry towards the point of radiation;
comparing the first distance and the second distance; and
activating the high energy radiations after the vehicle has crossed an offset when the second distance equals the first distance.

13. The method of claim 12 wherein the point of radiation comprises a beamline center of a linear accelerator.

14. The method of claim 12 comprising defining the offset by a user.

15. The method of claim 12 further comprising using at least one optical camera to capture the vehicle's profile and identifying markers to create a vehicle profile.
